(19) United States
(12) Patent Application Publication
(10) Pub. No.: US 2025/0004474 A1
(43) Pub. Date: Jan. 2, 2025

(54) ROUTE PLANNING METHOD AND DEVICE, AND STORAGE MEDIUM

(71) Applicant: SZ DJI TECHNOLOGY CO., LTD., Shenzhen (CN)

(72) Inventors: Xiang JI, Shenzhen (CN); Zhen ZHOU, Shenzhen (CN); Xinyue FANG, Shenzhen (CN)

(21) Appl. No.: 18/882,415

(22) Filed: Sep. 11, 2024

Related U.S. Application Data
(63) Continuation of application No. PCT/CN2022/082101, filed on Mar. 21, 2022.

(51) Int. Cl. G05D 1/224; G05D 109/20; G05D 111/10

(52) U.S. Cl. CPC G05D 1/2247; G05D 1/2246; G05D 2109/20; G05D 2111/10

(57) ABSTRACT

A route planning method includes displaying a perspective switching control and a current perspective display area on a route planning interface. The perspective switching control is configured to switch a current perspective image in the current perspective display area from a first perspective image to a second perspective image in response to a perspective switching instruction. The first perspective image is one of a plurality of perspective images including a first-person perspective image and a third-person perspective image. The second perspective image is another one of the plurality of perspective images. The method further includes, in response to a waypoint creation instruction, creating a waypoint based on a position of a movable platform in the current perspective image.

### CROSS-REFERENCE TO RELATED APPLICATION

This application is a continuation of International Application No. PCT/CN2022/082101, filed on Mar. 21, 2022, the entire content of which is incorporated herein by reference.

### TECHNICAL FIELD

The present disclosure relates to the field of movable platform and, more specifically, to a route planning method and device, and a storage medium.

### BACKGROUND

In recent years, movable platforms (e.g., UAVs) have been widely used in various fields. In order to allow the UAV to fly in a fully autonomous manner, the operator needs to draw and plan the UAV's route in advance. The UAV's route generally includes latitude and longitude position information, altitude information, and operation of mission equipment at each key waypoint on the route.

There are a variety of route planning software and equipment available. However, in such drawing software and equipment, the route is generally drawn from a third-person perspective, and the exact position of the route and the UAV, the gimbal direction, the shooting position, etc. cannot be accurately identified during the drawing.

### SUMMARY

In accordance with the disclosure, there is provided a route planning method including displaying a perspective switching control and a current perspective display area on a route planning interface. The perspective switching control is configured to switch a current perspective image in the current perspective display area from a first perspective image to a second perspective image in response to a perspective switching instruction. The first perspective image is one of a plurality of perspective images including a first-person perspective image and a third-person perspective image. The second perspective image is another one of the plurality of perspective images. The method further includes, in response to a waypoint creation instruction, creating a waypoint based on a position of a movable platform in the current perspective image.

Also in accordance with the disclosure, there is provided a route planning device including one or more storage devices storing one or more program instructions, a display configured to display a route planning interface, and one or more processors configured to execute the one or more program instructions to display a perspective switching control and a current perspective display area on a route planning interface. The perspective switching control is configured to switch a current perspective image in the current perspective display area from a first perspective image to a second perspective image in response to a perspective switching instruction. The first perspective image is one of a plurality of perspective images including a first-person perspective image and a third-person perspective image. The second perspective image is another one of the plurality of perspective images. The one or more processors are further configured to execute the one or more program instructions to, in response to a waypoint creation instruction, create a waypoint based on a position of a movable platform in the current perspective image.

Also in accordance with the disclosure, there is provided a non-transitory computer-readable storage medium storing at least one computer program that, when executed by at least one processor, causes the at least one processor to display a perspective switching control and a current perspective display area on a route planning interface. The perspective switching control is configured to switch a current perspective image in the current perspective display area from a first perspective image to a second perspective image in response to a perspective switching instruction. The first perspective image is one of a plurality of perspective images including a first-person perspective image and a third-person perspective image. The second perspective image is another one of the plurality of perspective images. The at least one computer program, when executed by at least one processor, further causes the at least one processor to, in response to a waypoint creation instruction, create a waypoint based on a position of a movable platform in the current perspective image.

### BRIEF DESCRIPTION OF THE DRAWINGS

FIG. 1 illustrates a flowchart of a UAV route planning method according to some embodiments of the present disclosure.

FIG. 2 illustrates a simplified diagram of a first-person perspective image according to some embodiments of the present disclosure.

FIG. 3 illustrates a schematic diagram of the first-person perspective image according to some embodiments of the present disclosure.

FIG. 4 illustrates a schematic diagram of a third-person perspective image according to some embodiments of the present disclosure.

FIG. 5 illustrates a simplified diagram of a setting box according to some embodiments of the present disclosure.

FIG. 6 illustrates a schematic diagram of a ring-shaped setting box according to some embodiments of the present disclosure.

FIG. 7 illustrates a schematic diagram of a waypoint auxiliary line according to some embodiments of the present disclosure.

FIG. 8 illustrates a structural diagram of an electronic device according to some embodiments of the present disclosure.

### DETAILED DESCRIPTION OF THE EMBODIMENTS

In order to make the objectives, technical solutions, and advantages of the present disclosure clearer, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings. In the case where there is no conflict between the exemplary embodiments, the features of the following embodiments and examples may be combined with each other.

The present disclosure can be described in the general context of computer-executable instructions such as program modules executed by a computer. Generally, program modules include routines, programs, objects, elements, and data structures, etc. that performs specific tasks or implement specific abstract data types. The present disclosure can also be practiced in distributed computing environments in which tasks are performed by remote processing devices connected through a communication network. In a distributed computing environment, program modules may be located in local and remote computer storage media including storage devices.

In the present disclosure, terms such as “module,” “system,” etc. may refer to related entities applied in a computer, such as hardware, a combination of hardware and software, software or software under execution, etc. In particular, for example, an element may be, but is not limited to, a process running on a processor, a processor, an object, an executable element, an execution thread, a program, and/or a computer. Also, an application program or a script program running on the server or the server may be an element. One or more elements can be in the process and/or thread in execution, and the elements can be localized in one computer and/or distributed between two or more computers and can be executed by various computer-readable media. Elements can also conduct communication through local and/or remote process based on signals comprising one or more data packets, for example, a signal from data that interacts with another element in a local system or a distributed system, and/or a signal from data that interacts with other systems through signals in a network of the internet.

The relationship terms used in the disclosure, such as first and second, are only for distinguishing an object or operation from another object or operation, but not for defining or implying any practical relation or order between the object or operation. The terms “include,” “contain” or other alternatives shall be non-exclusive, and the inclusion of a series of element such as process, method, object or equipment shall include not only the already mentioned elements but also those elements not mentioned, and shall include the elements which are inherent in the process, method, object or equipment. However, under the condition of no more limitations, the definition of an essential element limited by the sentence “including a . . . ” shall not obviate that in addition to containing the said essential element in the process, method, object or equipment, other essential element of the same nature may also exist in the above-mentioned process, method, object or equipment.

The embodiments described in the present disclosure use unmanned aerial vehicle (UAV) as an example, but the scope of the present disclosure is not limited thereto. The present disclosure is also applicable to any other suitable vehicles, such as a movable platform.

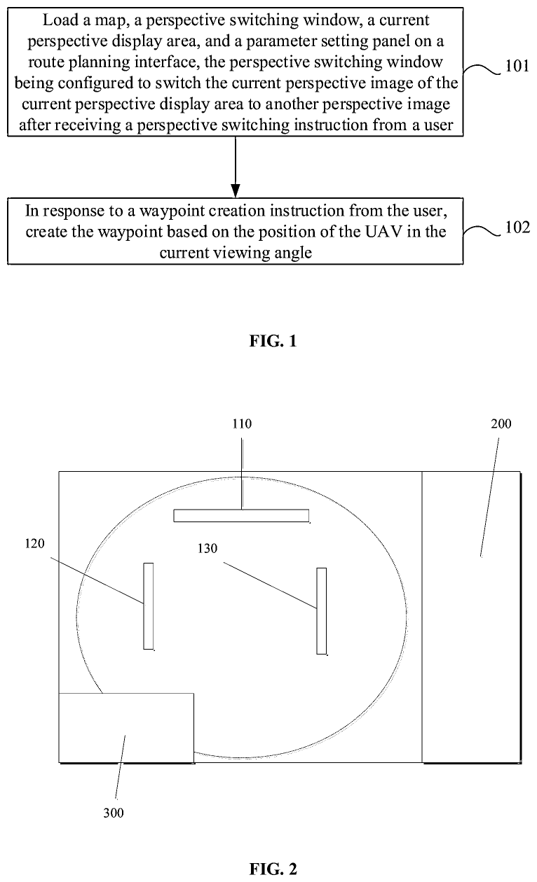

FIG. 1 illustrates a flowchart of an unmanned aerial vehicle (UAV) route planning method according to some embodiments of the present disclosure. The UAV route planning method of the present disclosure can be applied to a device for drawing a route, which can be a user device or a cloud platform. In actual applications, the device can be any one or more of a desktop computer, a laptop computer, a smart phone, a wearable device (such as a watch, a bracelet, etc.) and a remote control, which is not limited in the embodiments of the present disclosure. The device can be used to display a route planning interface. The UAV route planning method provided by the embodiments of the present disclosure can be applied to UAT operation tasks, such as agricultural plant protection tasks (such as spraying pesticides), aerial photography tasks, surveying tasks, etc., which is not limited in the embodiments of the present disclosure. The method will be described in detail below.

As shown in FIG. 1, at 101, a map, a perspective switching window, a current perspective display area, and a parameter setting panel are loaded on a route planning interface, where the perspective switching window is configured to switch the current perspective image of the current perspective display area to another perspective image after receiving a perspective switching instruction from a user. In some embodiments, the perspective image may include a first-person perspective image and a third-person perspective image.

At 102, in response to a waypoint creation instruction from the user, the waypoint is created based on the position of the UAV in the current viewing angle.

In the process at 101, for the user to draw a route, the route planning interface may load a map, a perspective switching window, a current perspective display area, and a parameter setting panel. The map can be a two-dimensional (2D) map or a three-dimensional (3D) map. For example, the spatial geographic information of a 3D map may be displayed on the route planning interface. The perspective switching window may be used to switch from one perspective image to another perspective image when triggered by the user. The perspective images may include the first-person perspective image and the third-person perspective image. For example, the first-person perspective image may be a cockpit image, and the third-person perspective image may be a cabin image. In this way, the current perspective display area can display the perspective image after the user makes the switch such that the user can choose to draw the route directly in the first-person perspective image on the 3D map. Subsequently, in the process at 102, in response to the user's waypoint creation instruction, a waypoint is created at the corresponding position in the perspective image displayed in the current perspective display area. This allows the user to draw waypoints and routes from a first-person perspective, and what the user sees is the image immediately after the image is taken.

In some embodiments, the perspective switching window may also display other to-be-switched-to perspective images in a picture-in-picture manner. For example, when the current perspective display area displays the first-person perspective image, the perspective switching window can display a thumbnail of the third-person perspective image. In other cases, other to-be-switched-to perspective images can also be displayed in a small window. For example, if the current perspective display area display the third-person perspective image, the screen will display the third-person perspective image, and the first-person perspective image will be displayed in a small window somewhere on the page, such as the lower left corner, which is not limited in the embodiments of the present disclosure. In addition, when different waypoints are selected in the third-person perspective image, the corresponding first-person perspective image can also switch along with the switching of the waypoint.

In a specific example, after the user enters the route planning interface, the default current screen may be the image outside the cabin, that is, the third-person perspective image, which mainly presents the relative position relationship between the waypoints and models (terrain) and displays the route trajectory. When the user clicks the map with the mouse, a waypoint is created at the corresponding location. Waypoint information and route information can be set in the parameter setting panel, and multiple waypoints can form a route. In response to the user clicking on different waypoints on the current perspective display area, switching between waypoints can be performed. After the waypoint is switched, the current screen will also switch with the waypoint, and the screen of a first payload (or waypoint) action of the current waypoint will be displayed by default. The interaction between the external image and the map can support common map operations, such as rotation, zooming, and dragging, which is not limited in the embodiments of the present disclosure. Subsequently, in response to the user clicking on the perspective switching window, the current screen can switch to the cockpit image. More specifically, the cockpit image can be switched to the current perspective display area, and the image outside the cabin can be switched back to the perspective switching window. At this time, the interface for editing the route from the first-person perspective is entered, and the displayed image is the area that the UAV will shoot.

In some embodiments, the method may also include: displaying at least the waypoint setting area in the first-person perspective image when the current perspective image is the first-person perspective image. The waypoint setting area allows the user to create waypoints, adjust the waypoint payload, or adjust the direction/altitude of the UAV corresponding to the waypoint. This allows the user to create waypoints, adjust the waypoint payload, or adjust the direction/altitude of the UAV corresponding to the waypoint in the first-person perspective, and the image the user currently sees is the image captured by the UAV. In some embodiments, adjusting the waypoint payload may include adjusting the hardware mounted on the UAV, such as the gimbal, camera, lighting, speaker, etc. For example, the angles of the gimbal, such as pitch, yaw, and roll, can be adjusted; the camera's parameters such as zoom ratio and aperture, can be adjusted; the color and brightness of the lighting can be adjusted; and the volume of the speaker can be adjusted.

In some embodiments, the first-person perspective image may also present some or all of the parameters in the primary flight display of the UAV, and the method may also include: updating some or all parameters in the primary flight display and the first-person perspective image in response to the user adjusting the waypoint payload. The primary flight display (PFD) may be a downward looking display that can comprehensively display various important flight parameters such as pitch, bank, flight altitude, speed, Mach number, vertical speed, heading, etc. By presenting some or all of the parameters in the primary flight display, users can have a better first-person perspective experience.

In some embodiments, the primary flight display may include operable UAV nose direction, gimbal pitch angle, and camera zoom. That is, the first-person perspective image can at least present controls that can adjust the UAV's nose direction, gimbal pitch angle, and camera zoom. In this case, the method may also include: in response to a user's operation instruction on any one of the UAV's yaw angle, altitude, gimbal pitch angle, gimbal yaw angle, and camera zoom, adjusting the UAV's yaw angle, altitude, gimbal pitch angle, gimbal yaw angle, and camera zoom correspondingly, and updating the first-person perspective image based on the adjustment. In this way, the UAV's nose direction, gimbal pitch angle, and camera zoom can be conveniently adjusted from the first-person perspective.

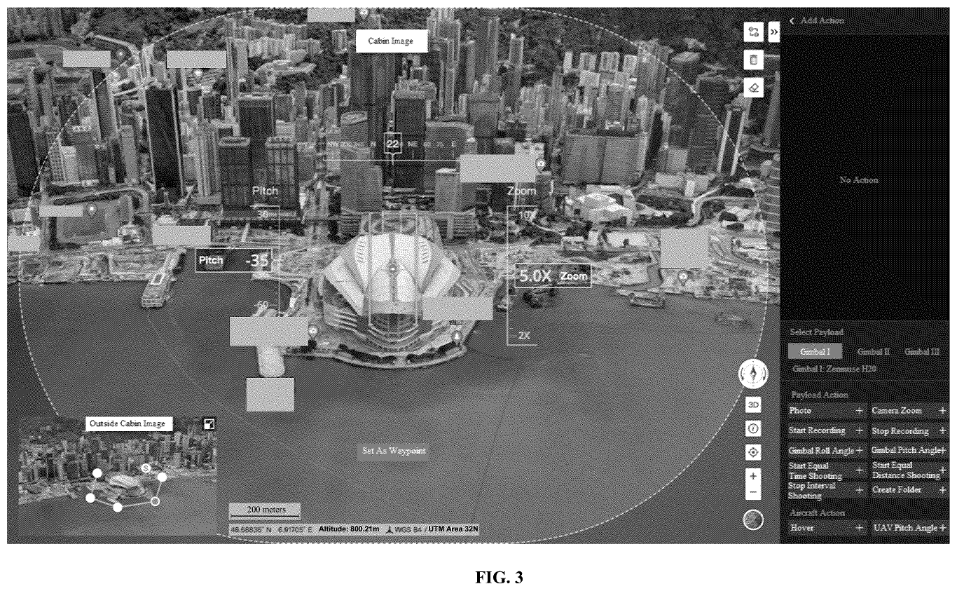

FIG. 2 illustrates a simplified diagram of a first-person perspective image according to some embodiments of the present disclosure. In some embodiments, the current perspective display area may display some or all parameters of the PFD. For example, the upper horizontal slider 110 may be used to control the horizontal heading angle (or yaw angle) of the nose of the UAV, and the user may press and hold ctrl and the left mouse button, and drag the slider horizontally to adjust the heading angle of the nose of the UAV. In another example, the right vertical slider 120 may be used to control the camera zoom, and the user may drag the right vertical slider with the mouse or directly use the mouse wheel to adjust the camera zoom multiple. In another example, the vertical slider on the left may be used to control the pitch angle of the gimbal, and the user may drag the left vertical slider 130 with the mouse to adjust the gimbal pitch angle between −90° to 30° by pressing and holding ctrl and the left button and dragging the vertical slider up and down. The pan/tilt of the UAV may be achieved by performing the dragging operations to adjust the top, bottom, left, and right of the screen that are consistent with the map operation, which is not limited in the embodiments of the present disclosure. The parameter setting panel 200 may be used to set route parameters and/or waypoint parameters, and the perspective switching window 300 may be used to switch perspectives.

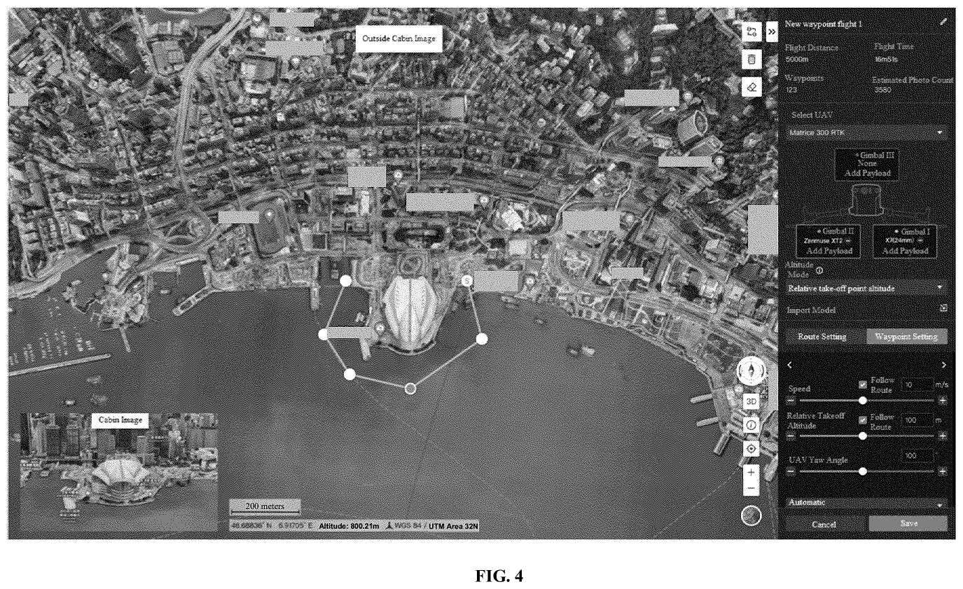

Refer to FIG. 3 and FIG. 4. FIG. 3 illustrates a schematic diagram of the first-person perspective image according to some embodiments of the present disclosure, and FIG. 4 illustrates a schematic diagram of a third-person perspective image according to some embodiments of the present disclosure.

As shown in FIG. 3, the current perspective display area displays the first-person perspective image, and the PFD is displayed on the screen. The slider above can control the angle of the UAV's nose. The number 22 in the middle of the slider is the current angle of the UAV's nose. The user can slide the slider left or right to change the nose direction, and the image displayed in the current perspective display area will also be updated accordingly. The left slider can be used to adjust the pitch angle of the UAV gimbal. The “pitch −35” in the middle of the slider is the current pitch angle of the UAV gimbal. The left slider can slide up and down to adjust the pitch angle of the gimbal, and the current image will be updated accordingly. The right slider can be used to adjust the UAV's camera zoom. The “5.0× Zoom” in the middle of the slider is the current zoom of the UAV. The right slider can slide up and down to adjust the camera zoom, and the current image will be updated accordingly. Of course, in other embodiments, the more setting sliders may be displayed to set more parameters, such as the yaw angle of the gimbal. The center point of the current cockpit image of the UAV may also be displayed in the middle of the three sliders, and a “set as waypoint” button may be displayed below. When the user clicks the button, a waypoint can be set at the current location, and the center point will be the center point of the captured image. The parameter setting panel may also be displayed on the right side of the entire screen, where the user can select the payload, such as gimbal I, gimbal II or gimbal III. Subsequently, the user may add payload actions to the selected gimbal, such as taking photos, adjusting camera zoom, starting recording, stopping recording, adjusting gimbal pitch angle, adjusting gimbal yaw angle, starting equal-time interval photo taking, starting equal-distance interval photo taking, ending interval photo taking, etc. The user may also click “Create Folder” to create a new payload action, or the user may choose to add aircraft actions such as hovering, adjusting UAV yaw angle, etc. In the lower left corner of the current perspective display area, a thumbnail of another perspective (currently the third-person perspective image) may also be displayed. When the user operates the current perspective display area, the other perspective image displayed in the lower left corner will also be updated, and the waypoint that is currently being operated can be seen from the third-person perspective image. Of course, if the user wants to delete the current waypoint, the user may also delete it through the trach can icon in the upper right corner of the current perspective display area. At the same time, the third-person perspective image will also be deleted and updated accordingly. The current perspective display area may also include some other common controls on maps, such as zoom in, zoom out, compass, 3D, etc., which will not be described in detail here.

As shown in FIG. 4, the current perspective display area displays the third-person perspective image, and the first-person perspective image is displayed as a picture-in-picture in the lower left corner. In the third-person perspective image, the user can set the route and waypoints by operating the parameter setting panel on the right. In the parameter setting panel, the name of the current route, route length, route execution time, number of waypoints, and estimated number of photos are displayed on top, the currently selected aircraft, the gimbals that can be selected and added, and the current altitude mode, such as the altitude relative to the take-off point are displayed in the middle, and route settings and waypoint setting are displayed at the bottom. Existing data can be imported by model import, and route setting and waypoint setting can be switched back and forth. When setting waypoints, different waypoints can be switched to and displayed. The parameters of each waypoint may include speed, relative take-off point altitude, aircraft yaw angle, aircraft rotation angle, etc. In some embodiments, the speed and relative take-off point altitude can be set to follow the route or individually, and the setting can be cancelled or saved once it is completed.

In some embodiments, the first-person perspective image may also present waypoint creation controls, and the method may also include: in response to the user's operation on the waypoint create controls, creating the current geographical location of the first-person perspective image as a waypoint, and displaying at least one action that can be added to the waypoint to the user. The action includes one or more of adjusting the aircraft yaw angle, adjusting the aircraft altitude, adjusting the gimbal pitch angle, adjusting the gimbal yaw angle, and adjusting the camera zoom. In this way, the user can easily create waypoints and add actions from the first-person perspective, which greatly improves the user experience.

In a specific example, on the first-person perspective image, when the image is the image needed for the user to create a waypoint, the user may click the “Save as Waypoint” button in the center of the screen (refer to FIG. 3) to create a waypoint at the current location. At this time, the direction of the camera in the screen is the position that the UAV needs to shoot during the waypoint flight. In response to the user manually adding or adjusting a payload action or a waypoint action, a corresponding waypoint action or payload action is added to the current waypoint. The current action number and total number of actions of the selected waypoint can be displayed the bottom of the screen as X/Y. In response to the user clicking the action arrow (< and >) on the screen, the payload action that needs to be executed can be switched back and forth. When the user creates a payload action or a waypoint action, a waypoint can be created directly at the aircraft position on the current screen. The new waypoint can be connected to the previous waypoint to form a new route. The current waypoint number and the total number of waypoints can be displayed at the top of the screen as X/Y.

In some embodiments, the method may also include: in response to the user's selected payload action being related to any one of gimbal pitch angle, gimbal yaw angle, and camera zoom ratio, displaying the direction of the payload action and an auxiliary line for adjusting the direction of the payload action on the map; in response to the user operating the auxiliary line, updating the direction of the payload action and the corresponding setting items in the parameter setting panel. In this way, when the user selects any of the above payload actions that can adjust the last captured image, the direction of the payload action and the auxiliary lines for adjusting the direction of the payload action can be displayed in the current perspective display area. Therefore, the user can adjust the direction of the payload action by operating the auxiliary line, and update the direction of the payload action displayed in the current perspective display area based on the user's operation, and update the adjusted parameters in the parameter setting panel. In addition, the user may also adjust the parameters that need to be adjusted by adjusting the corresponding setting items in the parameter setting panel, and this adjustment will also be synchronized to the current perspective display area. In this way, the user can intuitively adjust the payload action to obtain the desired shooting effect.

In some embodiments, the method may also include: in response to the user selecting the camera zoom, displaying the size of the shooting location corresponding to the current camera zoom on the map; in response to the user adjusting the zoom distance of the camera, updating the size of the shooting location. In this way, when the user adjusts the camera zoom, the size of the corresponding shooting location displayed in the current perspective display area will also be updated accordingly such that the user can better adjust the size of the final shooting area.

In some embodiments, the current perspective image may be the third-person perspective image, and the method further includes: in response to the user's preset operation on the waypoint, displaying a setting box on the map, the setting box including a selection button for any payload action among the aircraft yaw angle, gimbal pitch angle, and gimbal yaw angle; in response to the user's selection of any button, displaying the operation area corresponding to the selected payload action in the setting box, the operation area at least including the current direction of the payload action and an auxiliary line for adjusting the direction of the payload action. In this way, the payload action with orientation can be operated more conveniently through the setting box.

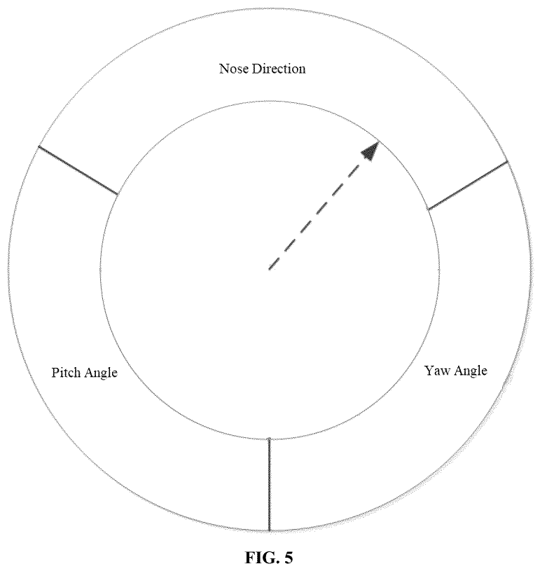

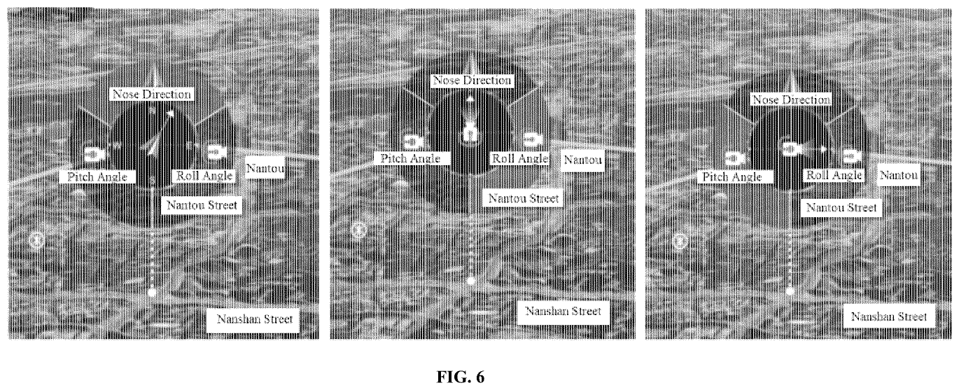

Refer to FIG. 5 and FIG. 6. In a specific example, a more convenient interaction solution between the aircraft and the gimbal position setting box may be as follows. For example, double-clicking a waypoint on the map will bring up a circular setting box where the user can select the aircraft's nose direction or the gimbal's pitch and yaw angles. When the “Nose Direction” is clicked, the center of the setting box will display an airplane icon (as shown in FIG. 6), and the indicator line (the dotted arrow line) can be dragged to adjust the nose direction of the aircraft to the specified direction. When the “Gimbal Yaw Angle” is clicked, the center of the setting box will display a horizontal gimbal icon (as shown in FIG. 6), and the indicator line (the dotted arrow line) can be dragged to adjust the gimbal's yaw axis direction. When the “Gimbal Pitch Angle” is clicked, the center of the setting box will display a pitch gimbal icon (as shown in FIG. 6), and the indicator line (the dotted arrow line) can be dragged to adjust the gimbal pitch angle.

In some embodiments, when the current perspective image is the third-person perspective image, creating a waypoint based on the position of the UAV in the current viewing angle in response to the user waypoint creation instruction may include: in response to a user marking a group point on the map, generating a waypoint on the map based on at least one parameter preset for the current route in the parameter setting panel. In this way, the user can crate waypoints more conveniently by marking points on the group. The user can preset at least one parameter of the current route. Subsequently, the user can create waypoints for the route, and each waypoint can have its own route parameters. In this way, there is no need to repeatedly set parameters for each waypoint. The route parameters can be set on the ground, which makes it easier for users to establish waypoints.

In some embodiments, when the current perspective image is the third-person perspective image, creating a waypoint based on the position of the UAV in the current viewing angle in response to the user waypoint creation instruction may include: in response to the user continuously marking multiple ground points on the map, generating a corresponding plurality of waypoints on the map based on at least one parameter preset for the current route in the parameter setting panel. Since the current route has at least one parameter preset, the user can select to follow the route when creating waypoints such that each waypoint created has the preset parameters of the route. In this way, the user can create waypoints by continuously marking points on the map, making it easy to create waypoints and routes.

In addition, if the user needs to modify the data of a certain waypoint, the user may also modify it individually in the parameter setting panel of the waypoint. The priority of modifying a waypoint individually can be higher than the priority of following the route, such that the subsequent user's parameter modification for a certain waypoint can overwrite the parameters preset by the original route. In some embodiments, at least one parameter of the route preset may also be a series of default parameters, such that the user does not need to deliberately set the route parameters before creating the waypoint, and the user can also use the method described above to quickly create waypoints when creating waypoints, which is not limited in the embodiments of the present disclosure.

In some embodiments, the at least one preset parameter may include altitude, flight speed, aircraft yaw angle mode, gimbal pitch angle control mode between waypoints and waypoint types. By presetting these parameters for the route, the creation of waypoints and routes can be completed more efficiently.

In some embodiments, the waypoint types may include: coordinated turn, no passing, early turn; straight flight, aircraft stops at the waypoint; curved flight, aircraft stops at the waypoint; and/or curved flight, aircraft passes the waypoint without stopping. By setting the waypoint type, the operation of the UAV on each section of the route can be controlled to better adapt to different tasks.

In other embodiments, the current waypoint image may also display the auxiliary lines for each waypoint's altitude above the ground. In this way, the altitude above the ground can be displayed in the current perspective image, thereby allowing the user to more clearly see the ground point corresponding to the waypoint.

In a specific example, for route planning from a third-person perspective, a 3D map may still be used as the base map. The interface layout can be the same as the first-person perspective, or different from the first-person perspective. For example, the route parameter setting panel and the waypoint parameter setting panel may be displayed on both sides such that the user can operate the route and waypoint more conveniently without switching back and forth in one panel. For example, the overall route data can be presented and adjusted in the route parameter setting panel on the left, and the single waypoint data can be presented and adjusted in the waypoint parameter setting panel on the right.

Waypoint drawing is the basis of the route, and a plurality of waypoints make up the route. When adding a waypoint, the user can enter the waypoint drawing state by clicking the add waypoint icon. When an added waypoint is selected, the mouse can be placed on the map and the cursor will turn into a pen drawing icon, making it easier to users to identify and operate. At this time, clicking on the map will create waypoints by marking points on the map. Continuous marking is supported, and the newly added waypoints will be selected. Marking points directly on the map is equivalent to marking the ground point. For example, the user can generate waypoints based on the altitude in the altitude mode of the route setting.

In some embodiments, the waypoint may have the nose orientation when displayed on the map, and the gimbal orientation may be displayed simultaneously when the waypoint is triggered and selected. By displaying the nose orientation on the waypoint, the user can see the nose orientation of the current waypoint more clearly and determine whether it needs to be modified.

In some embodiments, a plurality of waypoints may be interconnected to form a route, and a completion button may be provided at the end of the route. The method may further include: saving the route in response to a user operating on the completion button. By displaying the completion button on the last waypoint currently drawn, the user can click the completion button to create a route, which is more convenient and does not require setting up a new button on the current waypoint display interface.

In some embodiments, the map may include a 2D map and/or a 3D map, and the method may further include: in response to a user's map switching instruction, switching the 2D map to the 3D map or switching the 3D map to the 2D map. In this way, the user can switch maps based on preset instructions or operations to conveniently switch between 2D maps and 3D maps.

In some embodiments, when the map is a 3D map, the method may further include: in response to the user hovering over the waypoint, displaying the type and quantity of each payload action of the waypoint and displaying the height of the waypoint, the distance of the waypoint from the previous waypoint, and/or the distance of the waypoint from the next waypoint. In this way, corresponding feedback will be displayed for the hover operations to allow the user to see information related to a waypoint even if the user does not select a waypoint.

In some embodiments, when the current perspective image is the third-person perspective image and the map is a 3D map, the method may further include: in response to the user selecting a waypoint, displaying the viewing angle coverage of all payload actions of the waypoint. In this way, when the user selects a waypoint, the viewing angle coverage of all payload actions at the waypoint can be displayed, thereby allowing the user to clearly see the viewing angle coverage of each payload at the waypoint.

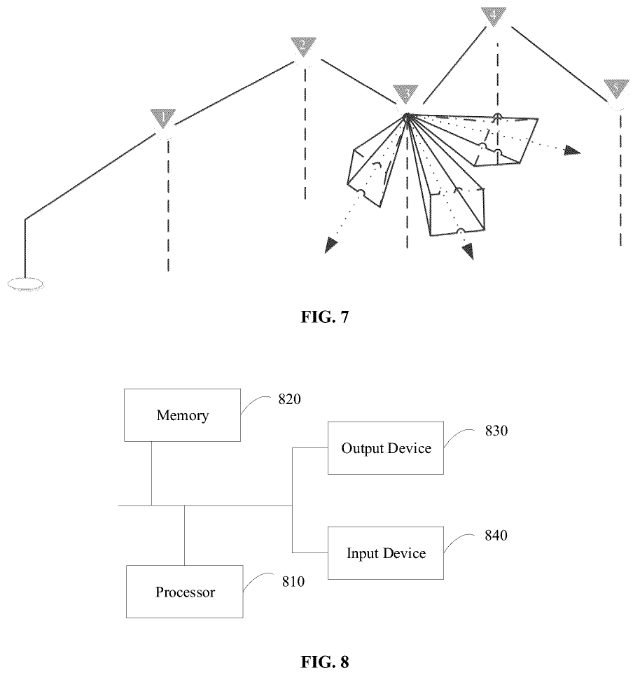

Refer to FIG. 7. In a specific example, the waypoint display can be an inverted triangle+the waypoint, and the waypoint can have direction indication. The direction may be the direction of the aircraft's nose. When the user selects a waypoint, the gimbal direction (not shown in FIG. 7) will also be displayed. When rotating a 2D map into a 3D map, all waypoints will float in the air and will be connected to the ground by a dotted line. In the 3D space, the point map will form a waypoint at the top of the clicked surface. After drawing, the user can click the check mark at the last waypoint mark (not shown in FIG. 7) to complete the waypoint creation.

The following are the states for route operations.

Hover state: the user can enter the hover state by hovering the mouse over the dotted line connected to the ground. The visual style can be to add 2 px white solid line with a transparency of 50% on this basis. After hovering to a point, the following can be displayed: “1> Display the action type and number of waypoints in the hover state.” The displayed content may include: “Waypoint action type, quantity”; “payload 1 action type, quantity”; “payload 2 action type, quantity”; “payload 3 action type, quantity.” In addition, the following information may also be displayed: “2> Ground height (ASL/AGL) (displayed on the vertical line above the ground); distance to the previous waypoint (displayed on the line connecting the previous waypoint); distance to the next waypoint (displayed on the line connecting the next waypoint).” Waypoints in the hover state can be deleted or dragged directly. The waypoint in the hover state will not call up the waypoint parameter setting panel on the right.

Selected state. The selected style may include the waypoint inverted triangle mark, waypoint, the ground dashed line and ground contact point, and selecting any one of the selection styles will select the entire element. The selected style may be an inverted triangular mark with a white border. The middle of the waypoint may have blue+white border, the ground line and contact point may turn white, and the ground line may turn yellow when it is being moved. Selected display (displayed information when a waypoint is selected): when a waypoint is selected, the length of the left and right routes and the height above the ground may be displayed. After clicking the selected point, the viewing angle coverage of all payloads and all actions at the waypoint can be displayed. Selected to move (move as a whole): the waypoint can be selected and moved. At this time, the waypoint inverted triangle mark, waypoint, the ground dashed line and ground contact point can be moved as a whole. At this time, when the mouse is hovered over the white ground line, the tooltip will display “Drag to change position.” The waypoint can be moved to anywhere that is clickable, and the line will turn yellow when it is being moved. Move right: when the mouse hovers over the selected waypoint, the tooltip will display “press and hold the Alt key and drag to change the height.” When the user presses and holds the Alt key, the mouse cursor will change to a ┌┘ icon, which can be clicked and dragged to adjust height of the waypoint. At this time, the line will turn yellow when it is being moved. Selected state usage: single-click selection: when the mouse is hovering over a certain waypoint, click the waypoint with the left mouse button (in the hover state) will change the waypoint from the hover state to the selected state. Single-click deselection: (1) hover the mouse over a selected waypoint, and click the waypoint with the left button (in the hover state); (2) close the right panel of the selected waypoint, after closing, the selected waypoint will be deselected and restored to the default state; (3) click the “ESC” button to deselect and restore to the default state. Product strategy: for a selected waypoint, the parameter panel for the selected waypoint must be displayed on the right side of the waypoint setting panel; when the parameter panel on the right side is closed, the selected waypoint will exit the selected state. The selected state of the waypoint is an editing state, which is linked to the switch state of the right panel. The waypoints that follow the route may be indicated in green, and the waypoints that do not follow the route may be indicated in blue. Altitude: when the route setting parameter is set to height to the ground, a solid line can be displayed, and when it is set to an altitude other than height to the ground, a dotted line can be displayed.

Waypoint action setting: when the waypoint is drawn, the user may add actions to the waypoint to enable the aircraft to perform tasks such as shooting at a fixed position. In the waypoint action settings, the user may set aircraft actions such as the aircraft's yaw angle; gimbal actions such as the gimbal yaw angle and gimbal pitch angle; and payload actions such as camera zoom.

Aircraft action. Take the aircraft yaw angle as an example. A waypoint is a point with a direction, and the yaw angle of the waypoint will change accordingly when the parameter is set in the parameter setting panel on the right.

Gimbal action. Gimbal action can be divided into gimbal yaw angle and gimbal pitch angle, which can help the user to understand where the aircraft is looking and what the aircraft is capturing. The overall interaction is as follows: select a waypoint on the map and select “gimbal yaw angle” and “gimbal pitch angle”; the gimbal's direction will appear on the route (as shown in FIG. 4), and there will be an auxiliary line in the direction (as shown by the dotted line with an arrow in FIG. 4); click the auxiliary line and drag it to move the direction of the gimbal, at this time, the settings in the right panel will change accordingly. Another method to adjust the gimbal action is by adjusting the parameters in the setting panel. As shown in the accompanying drawings, in the gimbal yaw angle setting, clicking the gimbal icon with the mouse and dragging the gimbal will change the direction, and the direction can be fine-tuned by entering a value. In the gimbal pitch angle setting, clicking the gimbal icon with the mouse and dragging the gimbal will change ethe pitch, which can be fine-tuned by entering a value.

Payload action: the camera zoom distance during payload action will affect the shooting results during route execution. As shown in the accompanying drawings, when the zoom factor is set in the parameter panel, the size of the shooting location can be viewed in the 3D map.

Route planning display: since the user can set the waypoint type when setting the route, different route tracks can be executed based on different settings. For example, the waypoint types may include: coordinated turn, no passing, early turn; straight flight, aircraft stops at the waypoint; curved flight, aircraft stops at the waypoint; and/or curved flight, aircraft passes the waypoint without stopping. The waypoint type can be selected by clicking on the drop-down menu. When different waypoint types are selected, the aircraft's route on the map will be displayed differently.

An embodiment of the present disclosure further provides a UAV route planning device. The device includes one or more storage devices for storing one or more program instructions; a display for displaying a route planning interface; and one or more processors for calling and executing the one or more program instructions stored in the storage device. When the one or more program instructions are being executed, the one or more processors will individually or collectively implement the method described in the foregoing embodiments.

An embodiment of the present disclosure further provides a storage medium having at least one computer program stored thereon. When the at least one program is being executed by at least one processor, a method consistent with the disclosure, such as one of the above-described example methods, can be implemented.

An embodiment of the present disclosure further provides a non-volatile computer-readable storage medium. The storage medium stores one or more programs including executable instructions, and the executable instructions can be read and executed by one or more electronic devices (including but not limited to computers, servers, or network devices, etc.) to implement the UAV route planning method described in the foregoing embodiments.

An embodiment of the present disclosure further provides a computer program product. The computer program product includes a computer program stored on a non-volatile computer-readable storage medium. The computer program includes program instructions that, when executed by a computer, causes the computer to implement the UAV route planning method described in the foregoing embodiments.

An embodiment of the present disclosure further provides an electronic device. The electronic device includes at least one processor, and at least one memory connected to the at least one processor. The at least one memory stores one or more instructions that can be executed by the at least one processor. When executed by the at least one processor, the one or more instructions can cause the at least one processor to implement a UAV route planning method consistent with the disclosure.

An embodiment of the present disclosure further provides a storage medium having at least one computer program stored thereon, which, when executed by at least one processor, causes the at least one processor to implement a UAV route planning method consistent with the disclosure.

Refer to FIG. 8. FIG. 8 illustrates a structural diagram of an electronic device for executing the UAV route planning method according to some embodiments of the present disclosure. As shown in FIG. 8, the device includes one or more processors 801 and one or more memories 802. For ease of description, FIG. 8 shows one processor 801 and one memory as an example.

In addition, the electronic device for executing the UAV route planning method also includes an input device 803 and an output device 804.

The processor 801, the storage 802, the input device 803, and the output device 804 may be connected via a bus or in other manners. For ease of description, FIG. 8 shows a bus connection as an example.

The memory 802 may be a non-volatile computer readable storage medium, and may be used to store non-volatile software programs, non-volatile computer executable programs and modules, such as program instructions/modules corresponding to the UAV route planning method of the present disclosure. The processor 801 may be configured to execute the non- volatile software programs, instructions and modules stored in the memory 802 to execute various functional applications and data processing operations of the server, such as implementing the UAV route planning method described in the foregoing embodiments.

The memory 802 may include a program storage area and a data storage area. The program storage area may be used to store application programs required by an operating system and at least one function. The data storage area may be used to store data created by using the UAT route planning method. In addition, the memory 802 may include a high-speed random-access storage, and may further include a non-volatile storage, for example, at least one magnetic disk storage device, a flash device, or other non-volatile solid-state storage devices. In some embodiments of the present disclosure, the memory 802 optionally may include storages remotely arranged relative to the processor 801, and the storage remotely arranged may be connected to the image processing device by means of a network. Examples of the network include, but are not limited to, an Internet, an enterprise intranet, a local area network, a mobile communication network, and a combination thereof.

The input device 803 may receive input digital information or character information, and generate a key signal input related to a user setting and function control of the image processing device. The output device 804 may include a display.

One or more modules may be stored in the memory 802. When the one or more modules are executed by the one or more processors 801, the UAV route planning method described above can be executed.

The electronic device may execute the method provided in the present disclosure, and have functional modules and beneficial effects corresponding to the method. Technical details not described in detail herein may be referred to the UAV route planning method provided in the embodiments of the present disclosure.

The electronic device of the embodiments of the present disclosure may be presented in various forms, including, but not limited to:
(1) a mobile communication device: such a device is characterized by having a mobile communication function, and is targeted for providing voice and data communication. Such device include: a smart phone (such as an iPhone), a multimedia mobile phone, a functional mobile phone, a low-end mobile phone, and the like.
(2) an ultra-mobile personal computer device: such a device belongs to a category of personal computers, has calculation and processing functions, and generally also has a mobile internet-surfing feature. Such a device includes: a PDA (Personal Digital Assistant), an MID (Mobile Internet Device), a UMPC (Ultra-mobile Personal Computer) device, and the like, such as an iPad®.
(3) a portable entertainment device: such a device may display and play multimedia content. The device includes: an audio and video player (for example, an iPod), a palm game machine, an electronic book, an intelligent toy, and a portable vehicle-mounted navigation device.
(4) a server: a device for providing a computing service, wherein a configuration of the server includes a processor, a hard disk, a memory, a system bus and the like, and the server is similar to a general-purpose computer architecture. However, since the server needs to provide a high-reliability service, the server needs to have high processing capability, stability, reliability, safety, expandability, manageability and the like.
(5) Other electronic devices having a data interaction function.

Some embodiments of the present disclosure are described above using UAV as an example. The present disclosure, however, is not limited to UAV. Methods and devices consistent with the disclosure can also be applied to any movable platform, such as other unmanned or manned vehicles.

The device embodiments described above are only illustrative; the units described as separate components may or may not be physically separate, parts displayed as units may or may not be physical units, they may be located in one place, or may be distributed across multiple network units. Some or all of the modules may be selected according to actual needs to achieve the purpose of the solution of certain embodiments.

Through the description of the above embodiments, those skilled in the art may clearly understand that the method of the above embodiments may be implemented by means of software plus necessary general hardware nodes. The method may also be implemented by hardware, but in many cases, the former is a better implementation manner. The technical solution of this application essentially or the part that contributes to the existing technology can be embodied in the form of a software product, and the computer software product stored in a storage medium (such as ROM/RAM, magnetic disk, optical disc) includes several instructions to enable a computer device (such as a personal computer, a server, or a network device, etc.) to execute the methods described in the various embodiments of the present disclosure.

Finally, the above exemplary embodiments are only used to illustrate the technical solutions of the present disclosure, but not to limit them. Although the present disclosure has been described in detail with reference to the foregoing exemplary embodiments, a person of ordinary skill in the art will understand as follows: it is still possible to modify the technical solutions disclosed in the foregoing exemplary embodiments, or to equivalently substitute some of the technical features thereof; however, these modifications or substitutions do not cause the essence of the corresponding technical solution to deviate from the principle and scope of the technical solution of each embodiment disclosed in the present disclosure.

What is claimed is:

1. A route planning method comprising:
displaying a perspective switching control and a current perspective display area-on a route planning interface, the perspective switching control being configured to switch a current perspective image in the current perspective display area from a first perspective image to a second perspective image in response to a perspective switching instruction, the first perspective image being one of a plurality of perspective images including a first-person perspective image and a third-person perspective image, and the second perspective image being another one of the plurality of perspective images; and
in response to a waypoint creation instruction, creating a waypoint based on a position of a movable platform in the current perspective image.

2. The method of claim 1,
wherein the current perspective image is the first-person perspective image;
the method further comprising:
displaying a waypoint setting area in the first-person perspective image, the waypoint setting area being configured for at least one of waypoint creation, waypoint payload adjustment, or adjustment of direction/altitude of the movable platform corresponding to the waypoint.

3. The method of claim 2,
wherein the first-person perspective image further presents a primary display of the movable platform;
the method further comprising:
in response to the waypoint payload adjustment, updating the primary display and the first-person perspective image.

4. The method of claim 3, further comprising:
in response to an operation instruction on an operation parameter of the movable platform, performing adjustment on the operation parameter, and updating the first-person perspective image based on the adjustment, the operation parameter including a yaw angle of the movable platform, an altitude of the movable platform, a pitch angle of a gimbal carried by the movable platform, a yaw angle of the gimbal, or a zoom of a camera carried by the movable platform.

5. The method of claim 1, further comprising:
in response to an operation on a waypoint creation control presented on the first-person perspective image, determining a geographical location of the first-person perspective image as the waypoint, and displaying at least one action to be added to the waypoint, the at least one action including one or more of a yaw angle of the movable platform, an altitude of the movable platform, a pitch angle of a gimbal carried by the movable platform, a yaw angle of the gimbal, or a zoom of a camera carried by the movable platform.

6. The method of claim 5, further comprising:
in response to a selected action being one of the pitch angle of the gimbal, the yaw angle of the gimbal, and the zoom of the camera, displaying, on a map, a direction of the selected action and an auxiliary line for adjusting the direction of the selected action; and
in response to an operation on the auxiliary line, updating the direction of the selected action and a corresponding setting item in a parameter setting panel.

7. The method of claim 5, further comprising:
in response to a selected action being the zoom of the camera, displaying, on a map, a size of a shooting location corresponding to a current zoom of the camera; and
in response to an adjustment on a zoom distance of the camera, updating the size of the shooting location.

8. The method of claim 1,
wherein the current perspective image is the third-person perspective image;
the method further comprising:
in response to a preset operation on the waypoint, displaying a setting box on a map, the setting box including one or more selection buttons for one or more payload actions, respectively, and the one or more payload actions including one or more of a yaw angle of the movable platform, a pitch angle of a gimbal carried by the platform, and a yaw angle of the gimbal; and
in response to a selection of one button of the one or more buttons, displaying an operation area corresponding to one payload action corresponding to the one button in the setting box, the operation area including at least a direction of the one payload action and an auxiliary line for adjusting the direction of the one payload action.

9. The method of claim 1, wherein:
the current perspective image is the third-person perspective image; and
creating the waypoint based on the position of the movable platform in the current perspective image in response to the waypoint creation instruction includes:
in response to marking of a ground point on a map, generating the waypoint on the map based on at least one parameter, in a parameter setting panel, preset for a current route.

10. The method of claim 1, wherein:
the current perspective image is the third-person perspective image; and
creating the waypoint based on the position of the movable platform in the current perspective image in response to the waypoint creation instruction includes:
in response to continuously marking of a plurality of ground points on a map, generating a plurality of corresponding waypoints on the map based on at least one parameter, in a parameter setting panel, preset for a current route.

11. The method of claim 10, wherein the at least one parameter includes altitude, speed, yaw angle mode of the movable platform, gimbal pitch angle control mode between waypoints, and waypoint type.

12. The method of claim 11, wherein the waypoint type includes at least one of:
coordinated turns, no overshooting, and turning ahead of time;
moving in a straight line and stopping at the waypoint;
moving in a curve and stopping at the waypoint; or
moving in a curve and passing through the waypoint without stopping.

13. The method of claim 1, wherein the perspective switching control includes a perspective switching window, and the perspective switching window is configured to display a first-person perspective image in response to a third-person perspective image displayed in the current perspective display area, or the perspective switching window is configured to display a third-person perspective image in response to a first-person perspective image displayed in the current perspective display area.

14. The method of claim 1, wherein the waypoint includes a nose direction when displayed on a map, and a gimbal direction is displayed simultaneously when the waypoint is triggered and selected.

15. The method of claim 1,
wherein a plurality of waypoints are connected to form a route and a completion button is provided at the last waypoint;
the method further comprising:
saving the route in response to an operation on the completion button.

16. The method of claim 1, further comprising:
loading a map, the first-person perspective image and the third-person perspective image being configured to display images in the map.

17. The method of claim 16,
wherein the map includes a three-dimensional map;
the method further comprising;
in response to the movable platform hovering over one waypoint, displaying at least one of a number of payload actions of the one waypoint, a type of each payload action, an altitude of the one waypoint, a distance from the one waypoint to a previous waypoint, or a distance from the one waypoint to a next waypoint.

18. The method of claim 16,
wherein the map includes a three-dimensional map and the current perspective image is the third-person perspective image;
the method further comprising:
in response to a selection of one waypoint, displaying a viewing angle coverage of all payload actions of the one waypoint.

19. A route planning device comprising:
one or more storage devices storing one or more program instructions;
a display configured to display a route planning interface; and
one or more processors configured to execute the one or more program instructions to:
display a perspective switching control and a current perspective display area on a route planning interface, the perspective switching control being configured to switch a current perspective image in the current perspective display area from a first perspective image to a second perspective image in response to a perspective switching instruction, the first perspective image being one of a plurality of perspective images including a first-person perspective image and a third-person perspective image, and the second perspective image being another one of the plurality of perspective images; and
in response to a waypoint creation instruction, create a waypoint based on a position of a movable platform in the current perspective image.

20. A non-transitory computer-readable storage medium storing at least one computer program that, when executed by at least one processor, causes the at least one processor to:
display a perspective switching control and a current perspective display area on a route planning interface, the perspective switching control being configured to switch a current perspective image in the current perspective display area from a first perspective image to a second perspective image in response to a perspective switching instruction, the first perspective image being one of a plurality of perspective images including a first-person perspective image and a third-person perspective image, and the second perspective image being another one of the plurality of perspective images; and
in response to a waypoint creation instruction, create a waypoint based on a position of a movable platform in the current perspective image.
